(19) United States
(12) Patent Application Publication
(10) Pub. No.: US 2003/0122866 A1
(43) Pub. Date: Jul. 3, 2003

(54) Method and apparatus for controlling device connected to home network through the internet

(75) Inventor: Hyun-gyoo Yook, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/259,837

(22) Filed: Sep. 30, 2002

(30) Foreign Application Priority Data
Sep. 29, 2001 (KR) 2001-61038

(51) Int. Cl. G09G 5/00

(52) U.S. Cl. 345/738

(57) ABSTRACT

A method and apparatus for controlling a device connected to a home network through the Internet are provided. The method is to control at least one device connected to a home network or home network system, wherein the home network system includes a controlling device having a controller for controlling at least one device through the home network. Also, the method includes installing a web server that can communicate with the controller and a web browser on a client connected to the Internet. With the method, it is possible to control a HAVi device by accessing a HAVi network via a web browser.

### BACKGROUND OF THE INVENTION

1. Field of the Invention

The present invention relates to a method for controlling a device connected to a home network, and more particularly, to a method and apparatus for controlling a controlled device connected to a home network through the Internet. The present application is based on Korean Patent Application No. 2001-61038, filed Sep. 29, 2001, which is incorporated herein by reference.

2. Description of the Related Art

Home audio video interoperability (HAVi) is one of home network standards, which connects electronic devices provided by various vendors via a network such that one electronic device can be controlled by another electronic device. An electronic device connected to a HAVi network is called a HAVi device. In a HAVi network, physical transmission of data is carried out according to the requirements provided by the Institute of Electric and Electronics Engineers (IEEE) 1394 standard. IEEE1394 allows asynchronous transmission or isochronous transmission. The asynchronous transmission mainly transmits control data and the isochronous transmission mainly transmits audio/video (AV) data.

FIG. 1 is a block diagram of a general HAVi network system. Referring to FIG. 1, HAVi devices 10, 20, 30, and 40 are connected to an IEEE1394 bus 1. The HAVi device 10 holds data-driven interaction (DDI) data 11 and has a DDI target 12 that is a device control module (DCM) or an application. The device 20 includes a user interface 22 having a display unit, and a DDI controller 21. The devices 30 and 40 denote a VTR and a camcorder, respectively.

The DDI data 11 has a tree structure for constituting a user interface screen, and the DDI target 12 is a control program for controlling the VTR 30 or the camcorder 40, i.e., a DCM or an application. The DCM or application holds required DDI data or produces DDI data dynamically. When a user requests to control the VTR 30 or the camcorder 40 through the user interface 22, the DDI controller 21 creates a user interface screen by parsing the DDI data 11 received from the DDI target 12, displays the result, and sends a control command input via the user interface screen to the DDI target 12. Next, the DCM or application 12 controls the VTR 30 or the camcorder 40 in response to the control command.

One problem with the existing HAVi systems is that they communicate based only on an IEEE1394 bus 1, and therefore are not compatible with other types of buses although these buses are physically or logically connected to an outer network. Another problem is that a user interface based on the DDI data 11 cannot be displayed using conventional Internet browsers.

### SUMMARY OF THE INVENTION

To solve the above and related problems, it is one object of the present invention to provide a method and apparatus for controlling a device connected to a home network through an Internet browser.

It is another object of the present invention to provide a method and apparatus for controlling a device connected to a HAVi network.

To achieve one aspect of the above objects, there is provided a method for controlling at least one device connected to a home network or a home network system, wherein the home network system includes a controlling device having a controller for controlling the at least one device through the home network, the method including (a) installing a web server that can communicate with the controller and a web browser on a client connected to the Internet.

Preferably, the method includes (b) the web server receiving a user control command from the web browser; (c) the web server sending the received control command to the controller; and (d) the controller sending the control command to a relevant device. More preferably, the method includes (e) the controller receiving responsive information from the at least one device with respect to the control command; (f) the controller converting the responsive information into a document of a format that can be displayed by the web browser; (g) the controller sending the document to the web server; and (h) the web server sending the document to the web browser.

The home network may be based on a protocol having home audio video interoperability (HAVi), and in (c) the received control command is sent via an application program interface (API).

(d) may include (d1) the controller sending the control command to a driver for controlling the at least one device; and (d2) the driver controlling the at least one device in response to the control command.

To achieve another aspect of the above objects, there is provided a method of controlling at least one device connected to a home network or a home network system, wherein the home network system includes a controlling device having a controller for controlling the device through the home network, the method including (a) a web server installed to communicate with the controller, receiving user information from a web browser on a client that is connected to the Internet, the web server registering the user information; (b) the web server receiving a request from the registered user, for a user interface screen corresponding to the device; (c) the web server sending the request to the controller; (d) the controller converting the requested user interface screen into a document that can be displayed by the web browser and sending the document to the web server; and (e) the web server sending the document to the web browser.

Preferably, (a) includes creating an API for interfacing the controller and the web server, and (d) includes the web server sending the request for the user interface screen to the controller via the API. Also, preferably, (e) includes (e1) sending the request for the user interface screen to a driver for controlling the device; and (e2) sending the requested user interface screen to the controller. The home network may be a HAVi network based on HAVi protocol, and the driver is a DDI target for DDI data.

More preferably, the API includes a general API having an identifier for identifying the DDI target, an identifier for the client, and an identifier for identifying a session set up between the web browser and the web server; an API for allowing a user to log in; an API for allowing the user to log out; an API for requesting the user interface screen; and an API for informing the client of the status of the controlled device.

To achieve still another aspect of the above objects, there is provided an apparatus for controlling at least one device connected to a home network through the Internet, the apparatus including a web server for receiving a user control command output from a web browser on a client that is connected to the Internet and sending the control command to a controller; and sending the control command to a relevant controlled device through the home network.

Preferably, the controller receives a responsive information from the controlled device with respect to the control command, converts the responsive information into a document that can be displayed by the web browser, and sends the document to the web server, and the web server sends the document to the web browser. Also, preferably, the home network is based on a HAVi protocol, and the web server sends the control command output from the client to the controller via the APIs.

The controller sends the control command to a driver for controlling the device, and the driver controls the device in response to the control command. More preferably, the home network is based on the HAVi protocol, and the driver is a DDI target.

The web server receives a request for a user interface screen corresponding to the controlled device from the client and sends the request to the controller, the controller converts the requested user interface screen into a document that can be displayed by the web browser and sends the document to the web server, and the web server sends the document to the web browser. The web server may communicate with the controller via the APIs, that is, it sends the request for the user interface screen to the controller via a relevant API. The controller sends the request for the user interface screen to the driver for controlling the controlled device and is given the requested user interface screen from the driver.

The API includes a general API having an identifier for identifying the DDI target, an identifier for the client, and an identifier for identifying a session set up between the web browser and the web server; an API for allowing a user to log in; an API for allowing the user to log out; an API for requesting the user interface screen; and an API for informing the client of the status of the controlled device.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a conventional HAVi network;

FIG. 2 is a block diagram of a preferred embodiment of a HAVi system according to the present invention;

FIG. 3 is a view of an example of the server unit shown in FIG. 2;

FIG. 4 is a diagram for explaining a method according to the present invention for controlling a device connected to a home network through the Internet; and

FIGS. 5A and 5B are diagrams for explaining a method for controlling a HAVi device connected to a HAVi network through an Internet browser, which is an example of performing the method explained in FIG. 4.

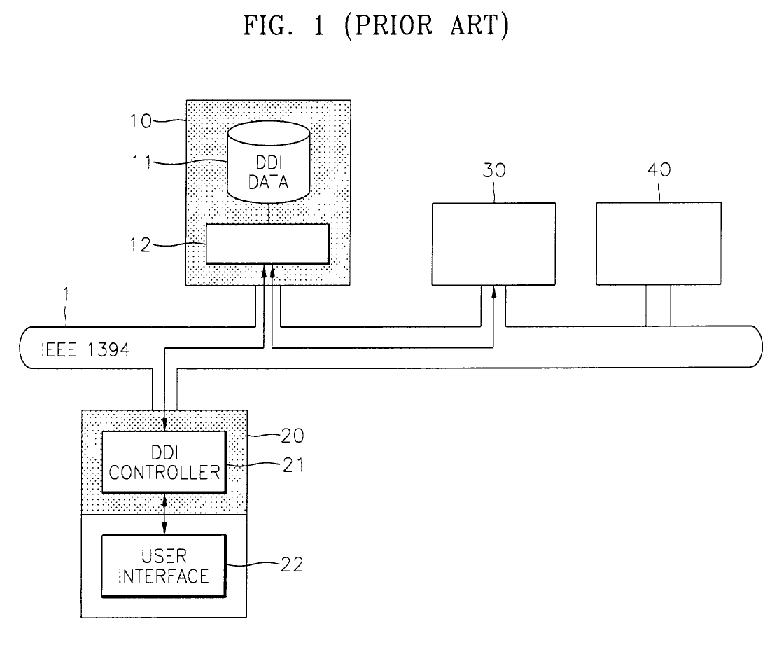

### DETAILED DESCRIPTION OF THE INVENTION

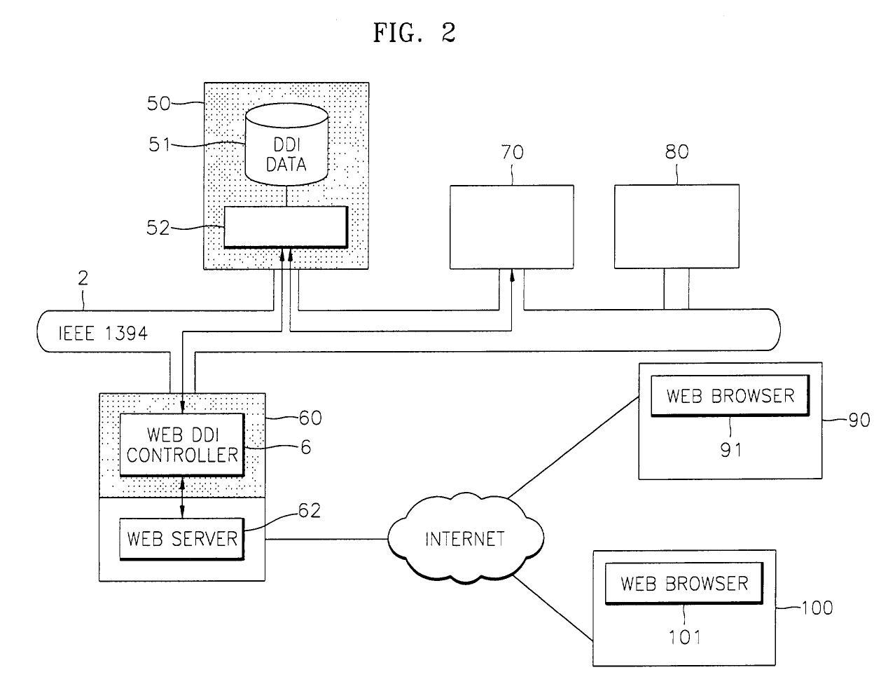

FIG. 2 is a block diagram of a home audio video interoperability (HAVi) system according to the present invention. Referring to FIG. 2, the HAVi system includes a plurality of HAVi devices 50, 60, 70, and 80 that are connected to an IEEE1394 bus 2. The HAVi devices 50 through 80 include the necessary elements to perform the following functions between each HAVi software in the HAVi devices 50 through 80, or have HAVi compliance. The HAVi software includes a 1394 communication media manager that enables IEEE1394 to communicate, a stream manager that manages real-time transmission of AV data, a messaging system that receives and transmits message, an event manager that performs an event transfer function, a device control module (DCM) for device control, a data driven interaction (DDI) data for a user interface, and a DDI controller. In case of the HAVi devices 50 through 80, HAVi compliance means that they do not follow a HAVi protocol but can be controlled by other HAVi devices.

For convenience, reference numerals 50 and 60, which can control the other HAVi devices 70 and 80, and the HAVi devices 70 and 80, which can be controlled by controlling devices 50 and 60, will now be referred to as controlling devices, and controlled devices, respectively. In particular, the controlling device 60 having a web server 62 will be referred to as a server unit.

The server unit 60 includes a web DDI controller 61 and the web server 62. The controlling device 50 holds DDI data 51 and has a DDI target 52. The DDI data 51 is data of a tree structure that has information to be used to make a user interface screen for a user interface. The DDI target 52 is a control code, i.e., a DCM or HAVi application, that is required to control the controlled device 70 and holds or dynamically creates DDI data.

The web server 62 communicates with clients 90 and 100, which have a web browser 91 and a web browser 101, respectively, through the Internet. That is, the web server 62 is given a request from the web browser 91 or 101, sends the request to the web DDI controller 61, receives a responsive information from the web DDI controller 61, and sends the responsive information to the web browser 91 or 101. The web server 62 also can send information to the clients 90 and 100, using the PUSH technique even though there is no request from the web browser 91 or 101. The web DDI controller 61 analyzes and processes the request from the web server 62, converts the result into a document that can be displayed by the web browsers 91 and 101, and sends the result to the web server 62.

If a user requests control of the controlled device 70 via the web browser 91 or 101, the web server 62 sends the request to the web DDI controller 61. Next, the web DDI controller 61 makes a user interface screen by parsing the DDI data 51 received from the DDI target 52, converts the user interface screen into a document, e.g., a HyperText Markup Language (HTML) document, that can be displayed by the web browsers 91 and 101, and sends the document to the web server 62. The web server 62 receives the document from the web DDI controller 61 and sends it to the web browsers 91 and 101. Then, the web browsers 91 and 101 display the received document. As a result, the document is displayed on the clients 90 and 100. A user's control command input from the user interface screen is sent to the web DDI controller 61 via the web browsers 91 and 101 and the web server 62. The web DDI controller 61 transfers the user's control command to the DDI target 52. Finally, the DDI target 52 controls the controlled device 70 in response to the user's control command.

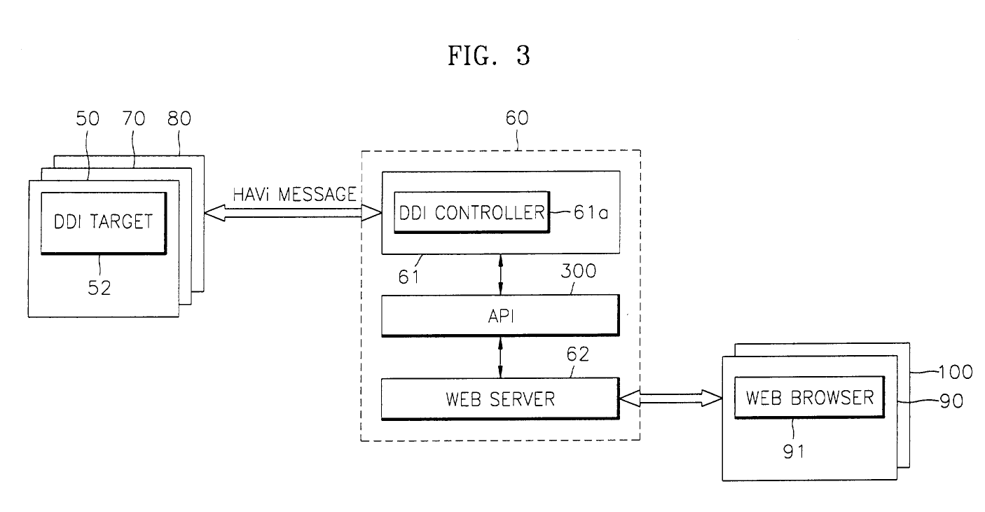

FIG. 3 is a view of an example of the server unit 60 of FIG. 2. Referring to FIG. 3, the web DDI controller 61 which is built in the server unit 60 includes a DDI controller 61a. The DDI controller 61a exchanges HAVi messages with the HAVi devices 50, 70, 80 according to a HAVi protocol. The web DDI controller 61 and the web server 62 communicate with each other via an application program interface (API) 300. The API 300 is a ‘method’ of exchanging information between an operating system and an application program or between application programs. The API 300 sends a request of a user, which is received by the web server 62 from the web browsers 91 and 101, to the web DDI controller 61, receives a responsive information from the web DDI controller 61, and sends the responsive information to the web server 62. The web DDI controller 61 interprets parameters, which are received from the API 300, to be readable by the DDI controller 61a, i.e., converts the parameters into DDI controller parameters, and sends the result to the DDI controller 61a. Further, the web DDI controller 61 processes the responsive information from the DDI controller 61a and sends the result to the API 300.

The API 300 according to the present invention is classified into a general API and a DDI controller API for the web DDI controller 61. As the general API parameters there are TargetId, ClientId, and SessionID, and as the DDI controller API parameters there are DDIController :: Subscribe, DDIController :: Unsubscribe, DDIController :: GetPage and DDIController :: UserAction. Also, the API 300 according to the present invention may be <Client> :: NotifyPageChange that can provide information on the state of the HAVi devices 50 through 80 even though there is no request from the web browsers 91 and 101 which are clients.

The followings are descriptions of the above APIs:

(a) TargetID

Struct TargetID{

Sequence <char> uri;

}

TargetID is used to distinguish the DDI target 52 from various DCMs or applications for various HAVi devices. In general, “uri” parameter is described in the form of a uniform resource locator (URL).

(b) ClientId

Struct ClientID{

Sequence <char> uri;

}

ClientId is defined to send information on the HAVi devices 50 through 80 to the web browsers 91 and 101, using a PUSH technique, when there is no request from the web browsers 91 and 101. In other words, ClientID is used to display the user interface (UI) of the DDI target 52 and recognize the web browsers 91 and 101, or an equivalent device, to which information is input by a user. As in TargetID, the form of the “uri” parameter may vary according to an adopted PUSH technique.

(c) SessionID

Struct SessionID{

SEID ddiTargetSeid;
ushort sessionHandle;

}

SessionId is used to memorize the information of the web browsers 91 and 101 which the web DDI controller 61 requires to obtain. That is, SessionId is stored as a session or cookie, which is set between the web browsers 91 and 101 and the web server 62, in the clients 90 and 100.

(d) DDIController :: Subscribe

Status DDIController :: Subscribe(IN TargetId targetId, IN ClientId
clientID, Out SessionId sessionId)

DDIController :: Subscribe is an API (application program interface) in which a user identifier and password are registered to allow a user to log in and access the web server 62. This API prevents an unauthorized user from accessing the web server 62 through the web browsers 91 and 101 and controlling the HAVi devices 50 through 80. As parameters, there are targetid which is an identifier of the DDI target 52, clientld which is an identifier of the DDI target 52 to be interfaced with the user, and sessionid which is a state identifier provided by the web DDI controller 61. In detail, DDIController :: Subscribe enables user registration, i.e., DdiTarget :: Subscribe, for the DDI target 52 corresponding to targetld which is the identifier of a HAVi device the user requests, and provides equivalent sessionld. Here, DdiTarget :: Subscribe is an API that is defined in HAVi protocol.

(e) DDIController :: Unsubscribe

Status DDIController :: Unsubscribe(IN SessionId sessionId)

DDIController :: Unsubscribe is an API that allows the user to log out, in which sessionld the web DDI controller 61 sets is used as a parameter. This API terminates the existing session which was set up for communication when the web browsers 91 and 101 of the clients 90 and 100 do not communicate with the DDI target 52 any longer.

(f) Controller :: GetPage

Status DDIController :: GetPage(IN SessionId sessionId, OUT String
page)

Controller :: GetPage is an API having parameters such as sessionid and page and through which a user requests a user interface screen that is displayed by the web browsers 91 and 101. Here, page indicates a document that is to be displayed at the web browsers 91 and 101, and includes all DDI elements contained in rootPanel of the web DDI controller 61. The rootPanel is defined in the HAVi protocol and is a data structure to make the user interface screen. In general, the page is an HTML document into which an applet coded with client interpretive program language such as Script and JavaScript may be inserted. This API enables the user interface screen, which is displayed by the web browsers 91 and 101, to be provided as a page.

(g) DDIController :: UserAction

Status DDIController :: UserAction(IN SessionId sessionId, IN Int action,
OUT String page)

DDIController :: UserAction is an API for sending a user control command input via the user interface screen. This API has as parameters sessionld, action, and page. Here, action is a parameter that describes a user's input to be sent to the DDI target 52. Conversion of the action into DdiACtions is performed by the web DDI controller 61. The DdiACtion is a parameter that is defined in the HAVi protocol and provided to the DDI target 52 to allow the user's input to be sent to the web DDI controller 61. The web DDI controller 61 parses new DDI data, which was converted to correspond to the user's input, with the DDI target 51, creates a document for a new user interface screen, and provides the document to the web server 62 via the next page.

(h) <Client> :: NotifyingPageChange

Status <Client> :: NotifyPageChange(IN ClientID, clientID, IN String
page)

<Client> :: NotifyingPageChange is an API for informing the clients 90 and 100 of status changes of the HAVi devices 50 through 80 and has parameters such as clientId and page. The clientID is an identifier of the client 90 or 100 which maintains a session with respect to the DDI target 52 having changed DDI data 51. The page indicates a user interface screen that is newly produced to include the changed DDI data 51. If a change is made to the DDI data 51 of the DDI target 52 without a user's request, the web DDI controller 61 produces a new user interface screen containing the change and provides the web server 62 with the screen. Then, the web server 62 sends the new user interface screen to the web browsers 91 and 101. At this time, a PUSH technique can be used.

The PUSH technique includes all kinds of techniques of transferring information from a server to a client. In this regard, Microsoft has introduced Webcasting, a PUSH technique adopted by the Internet Explorer, and Netscape has added a new element, ‘Netcaster’, into its Netscape browser, which enables sending of information using the PUSH technique. In addition, there are other various PUSH techniques, but an international standard thereof has yet to be determined. In the event that a standard PUSH technique is set, the PUSH parameters of an API suggested in this disclosure can be changed appropriately.

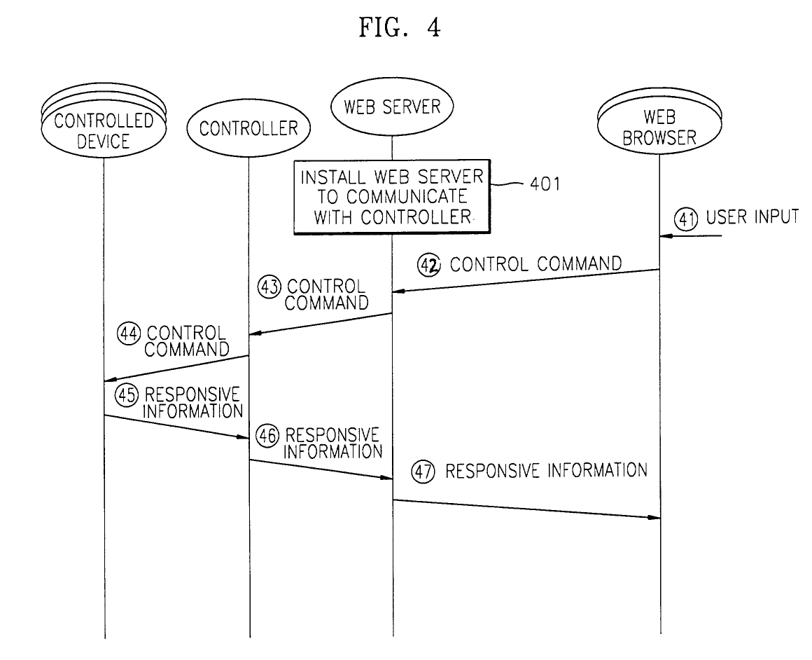

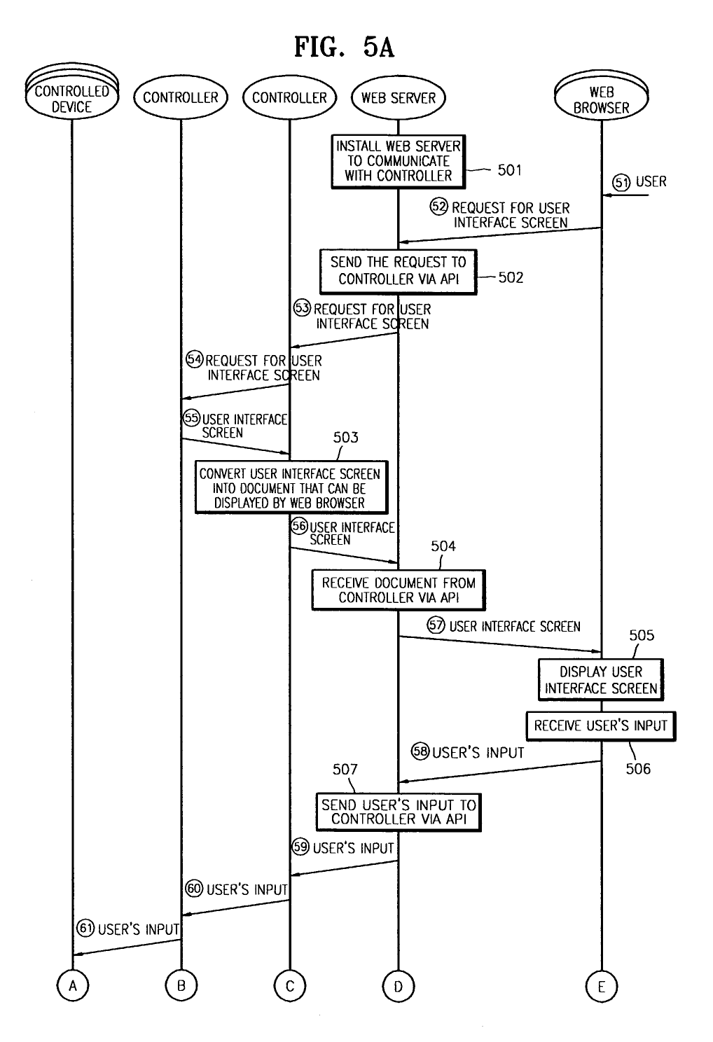

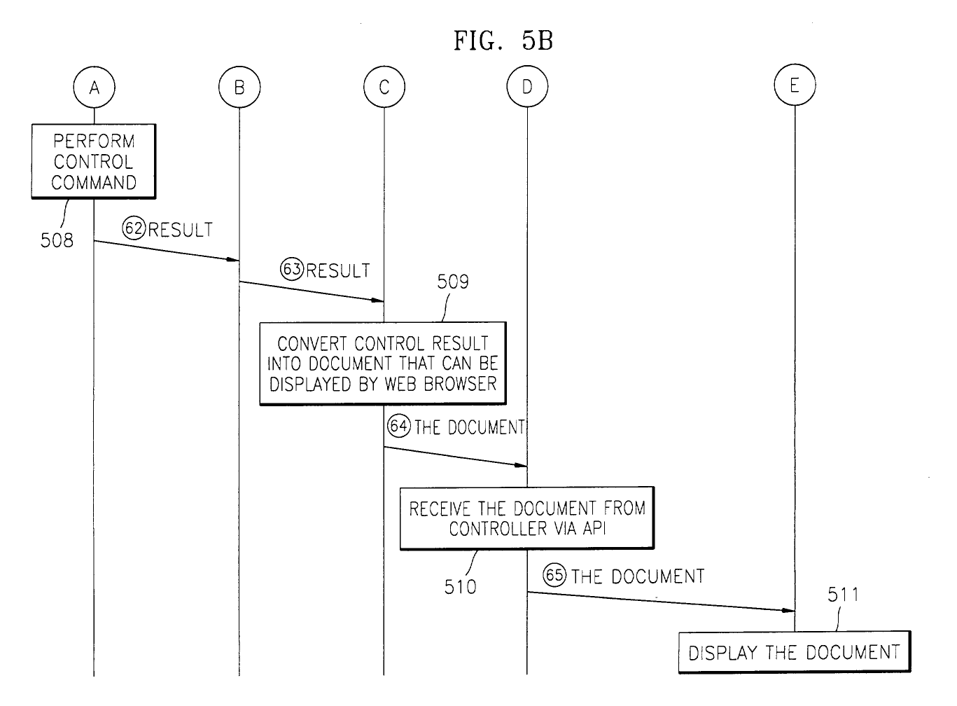

Hereinafter, preferred embodiments of a method of controlling a device connected to a home network through the Internet according to the present invention, will be described with reference to FIGS. 4, 5A, and 5B.

FIG. 4 is a diagram illustrating a preferred embodiment of a method of controlling a device connected to a home network through the Internet. Referring to FIG. 4, a web server is installed in a controlling device having a controller for controlling a device connected to a home network through the home network in step 401. The web server is installed to communicate with the controller, which is described in the following implementation.

After step 401, when a user control command is input to the web server via a web browser in sub-step 41, the web receives the user control command from the web browser via the Internet in sub-step 42. Thereafter, the web server sends the received control command to the controller in sub-step 43 and the controller sends it to a related controlled device in sub-step 44. Next, the controlled device is actuated in response to the control command and informs the controller of the result such as information regarding its status change, in sub-step 45. The controller sends the received result to the web server in sub-step 46 and the web server sends it to the web browser in sub-step 47.

FIGS. 5A and 5B are for explaining a method for controlling the controlled devices 50, 70, and 80, which are HAVi devices, and connected to a HAVi network, through the Internet, which is one example of performing the method of FIG. 4. Referring to FIGS. 2, 5A, and 5B, in step 501, the web server 62 is installed in the controlling device 60, which is also a HAVi device and has the web DDI controller 61 for controlling the controlled devices 50, 70, and 80 through the HAVi network, such that the web server 62 can communicate with the DDI controller 61a. The installation of the web server 62 to communicate with the DDI controller 61a is implemented by the web DDI controller 61 and the API 300.

After step 501, a user requests a user interface screen in sub-step 51, the web browsers 91 and 101 transmit the user's request to the web server 62 through the Internet in sub-step 52. The web server 62 sends the user's request to the web DDI controller 61 via an API in sub-step 502. The web DDI controller 61 receives the user's request via the API in sub-step 53 and then sends it to the DDI target 52, which is a DCM or an application which controls a relevant controlled device 50, 70, or 80 in sub-step 54. The DDI target 52 sends a relevant user interface screen to the web DDI controller 61 in sub-step 55. The web DDI controller 61 converts the user interface screen into a format that can be displayed by the web browsers 91 and 101 in step 503 and sends the converted user interface screen to the web server 62 in sub-step 56. The web server 62 receives the user interface screen via the API in step 504 and sends the received user interface screen to the web browsers 91 and 101 through the Internet in sub-step 57. Next, the web browsers 91 and 101 display the user interface screen in step 505.

After step 505, the web browsers 91 and 101 receives a user's input via the user interface screen in step 506 and sends it to the web server 62 in sub-step 58. Next, the web server 62 sends the received user's input to the web DDI controller 61 via the API in step 507. The web DDI controller 61 receives the user's input in sub-step 59, and sends it to the DDI target 52 in sub-step 60 and then to the controlled device 70 in sub-step 61. Next, the controlled device 70 carries out a control operation according to the user's input in step 508, and the result is sent to the DDI target 52 in sub-step 62 and then to the web DDI controller 61 in sub-step 63. After sub-step 63, the web DDI controller 61 changes the received control result into a document of a format that can be displayed by the web browsers 91 and 101 in step 509, and then sends the document to the web server 62 in sub-step 64. The web server 62 sends the document to the web browsers 91 and 101 through the Internet in sub-step 65, and the web browsers 91 and 101 display the document in step 511.

A method and apparatus for controlling a device connected to a home network through the Internet according to the present invention, may be realized as a program code that can be executed by a computer, and can be recorded on a computer-readable information storage medium.

As described above, according to the present invention, a device connected to a home network can be controlled through the Internet. In particular, it is possible to control HAVi devices by accessing a HAVi network through a web browser.

What is claimed is:

1. A method for controlling at least one device connected to a home network or a home network system, wherein the home network system includes a controlling device having a controller for controlling the at least one device through the home network, the method comprising (a) installing a web server that can communicate with the controller and a web browser on a client connected to the Internet.

2. The method of claim 1 further comprising:
(b) the web server receiving a user control command from the web browser;
(c) the web server sending a received control command to the controller; and
(d) the controller sending the control command to a relevant device.

3. The method of claim 1 further comprising:
(e) the controller receiving responsive information from the at least one device with respect to the control command;
(f) the controller converting the responsive information into a document of a format that can be displayed by the web browser;
(g) the controller sending the document to the web server; and
(h) the web server sending the document to the web browser.

4. The method of claim 2, wherein the home network is based on a protocol having home audio video interoperability (HAVi), and in (c) the received control command is sent via an application program interface (API).

5. The method of claim 2, wherein (d) comprises:
(d1) the controller sending the control command to a driver for controlling the at least one device; and
(d2) the driver controlling the at least one device in response to the control command.

6. The method of claim 5, wherein the home network is based on a HAVi protocol, and the driver is a data-driven interaction (DDI) target.

7. The method of claim 3, wherein the home network is based on a HAVi protocol, and in (g) the controller sends the document to the web server via an API.

8. A method of controlling at least one device connected to a home network or a home network system, wherein the home network system includes a controlling device having a controller for controlling the device through the home network, the method comprising:
(a) a web server installed to communicate with the controller, receiving user information from a web browser on a client that is connected to the Internet, the web server registering the user information;
(b) the web server receiving a request for a user interface screen corresponding to the device from a registered user;
(c) the web server sending the request to the controller;
(d) the controller converting the requested user interface screen into a document that can be displayed by the web browser and sending the document to the web server; and
(e) the web server sending the document to the web browser.

9. The method of claim 8, wherein (a) comprises creating an API for interfacing the controller and the web server.

10. The method of claim 9, wherein (d) comprises the web server sending the request for the user interface screen to the controller via the API.

11. The method of claim 10, wherein (e) comprises:
(e1) sending the request for the user interface screen to a driver for controlling the device; and
(e2) sending the requested user interface screen to the controller.

12. The method of claim 11, wherein the home network is a HAVi network based on a HAVi protocol, and the driver is a DDI target for DDI data.

13. The method of claim 9, wherein the API comprises:
a general API having an identifier for identifying a DDI target, an identifier for the client, and an identifier for identifying a session set up between the web browser and the web server;
an API for allowing a user to log in;
an API for allowing the user to log out;
an API for requesting the user interface screen; and
an API for informing the client of a status of the controlled device.

14. An apparatus for controlling at least one device connected to a home network through the Internet, the apparatus comprising:
a web server for receiving a user control command output from a web browser on a client that is connected to the Internet and sending the control command to a controller; and
sending the control command to a relevant controlled device through the home network.

15. The apparatus of claim 14, wherein the controller receives a responsive information from the controlled device with respect to the control command, converts the responsive information into a first document that can be displayed by the web browser, and sends the first document to the web server, and the web server sends the first document to the web browser.

16. The apparatus of claim 15, wherein the home network is based on a HAVi protocol, and the web server sends the control command output from the client to the controller via APIs.

17. The apparatus of claim 14, wherein the controller sends the control command to a driver for controlling the device, and the driver controls the device in response to the control command.

18. The apparatus of claim 17, wherein the home network is based on a HAVi protocol, and the driver is a DDI target.

19. The apparatus of claim 15, wherein the web server receives a request for a user interface screen corresponding to the controlled device from the client and sends the request to the controller,
the controller converts the requested user interface screen into a second document that can be displayed by the web browser and sends the second document to the web server, and
the web server sends the second document to the web browser.

20. The apparatus of claim 19, wherein the web server communicates with the controller via APIs.

21. The apparatus of claim 19, wherein the web server sends the request for the user interface screen to the controller via a relevant API.

22. The apparatus of claim 19, wherein the controller sends the request for the user interface screen to a driver for controlling the controlled device and is given the requested user interface screen from the driver.

23. The apparatus of claim 22, wherein the home network is a HAVi network based on a HAVi protocol, and the driver is a DDI target for DDI data.

24. The apparatus of claim 20, wherein the API comprises:
a general API having an identifier for identifying a DDI target, an identifier for the client, and an identifier for identifying a session set up between the web browser and the web server;
an API for allowing a user to log in;
an API for allowing the user to log out;
an API for requesting the user interface screen; and
an API for informing the client of a status of the controlled device.

25. An information storage medium for recording a computer program code for enabling a computer to provide a service of controlling at least one device connected to a home network or a home network system, wherein the home network system includes a controlling device having a controller for controlling the at least one device through the home network, the service comprising steps of:
(a) installing a web server that can communicate with the controller and a web browser on a client connected to the Internet;
(b) the web server receiving a user control command from the web browser;
(c) the web server sending a received control command to the controller; and
(d) the controller sending the control command to a relevant device.
